(19) United States
(12) Patent Application Publication
(10) Pub. No.: US 2026/0075073 A1
(43) Pub. Date: Mar. 12, 2026

(54) AUTOMATED NETWORK INFRASTRUCTURE DIAGNOSTIC OPERATIONS USING GENERATIVE ARTIFICIAL INTELLIGENCE

(71) Applicant: NVIDIA Corporation, Santa Clara, CA (US)

(72) Inventors: James CAMERON, Fredericton (CA); Lilach ILAN, Alpharetta, GA (US); Zahra RONAGHI, Bowling Green, KY (US); Friederich DEVOIR, Pilot Point, TX (US); Maria Amparo CANAVERAS GALDON, Montville, NJ (US)

(73) Assignee: NVIDIA Corporation, Santa Clara, CA (US)

(21) Appl. No.: 18/883,076

(22) Filed: Sep. 12, 2024

(51) Int. Cl. H04L 9/40

(52) U.S. Cl. CPC H04L 63/1425; H04L 63/1441

(57) ABSTRACT

In various examples, systems and methods are disclosed relating to automated network infrastructure diagnostic operations using generative artificial intelligence. A system can classify at least one log of a set of logs produced by a network system as corresponding to a network anomaly. Upon classifying the at least one log as corresponding to the network anomaly, the system can generate, using a machine-learning model and the at least one log, a command to produce a message comprising natural language output identifying the network anomaly. The system can cause performance of one or more maintenance actions on the network system based on the message to address the network anomaly.

### BACKGROUND

Network systems for telecommunications produce large volumes of log information—up to billions of logs per day. Log information produced by such systems includes data that may be useful in performing diagnostic operations for the network systems. Conventional network diagnostic operations rely on detecting specific errors or metrics using hardcoded, rule-based systems. Such approaches have limited context and require manual intervention when issues are detected. The volume and complexity of log information make it challenging to detect and rectify problems in such network infrastructures.

### SUMMARY

The techniques described can be used to efficiently identify and process indications actual or potential abnormalities in large network infrastructures, including large telecommunications infrastructures. In particular, the systems and methods described herein can ingest and classify log data produced by devices of a network infrastructure as potentially corresponding to an anomaly, error, or unexpected condition. Log data that is classified as potentially anomalous is provided as input to a generative machine-learning model, such as a variant of a large language model, for further classification and processing.

Embodiments described herein implement generative machine-learning models that can be trained/updated using datasets derived from a telecommunications network, such that the model can automatically identify and generate potential resolutions for any detected network issues. Data used to train/update the machine-learning model may include manuals, industry-standard documentation, textbook data, among other information relevant to a particular network infrastructure. The output of the generative machine-learning model can be used to automatically generate actions or actionable data, which can be used to directly address or provide context for addressing network anomalies in large network systems.

At least one aspect relates to one or more processors. The one or more processors can include one or more circuits. The one or more circuits can classify at least one log of a set of logs produced by a network system as corresponding to a network anomaly. Upon classifying the at least one log as corresponding to the network anomaly, the one or more circuits can generate, using a machine-learning model and the at least one log, a command to produce a message comprising natural language output identifying the network anomaly. The one or more processors can cause performance of one or more maintenance actions on the network system based on the message to address the network anomaly.

In some implementations, the machine-learning model comprises a large language model. In some implementations, the natural language output further identifies a potential solution for the network anomaly. In some implementations, the one or more circuits can generate, based at least on the command, a service ticket identifying the network anomaly and the potential solution for the network anomaly. In some implementations, the one or more circuits can transmit the command to at least one external system associated with the network system.

In some implementations, the one or more circuits can receive, from a computing device, a natural language query corresponding to the network system. In some implementations, the one or more circuits can generate, using the machine-learning model and the natural language query, a second natural language output corresponding to the natural language query. In some implementations, the one or more circuits can retrieve a dataset corresponding to the natural language query from a data source. In some implementations, the one or more circuits can generate the second natural language output using the natural language query and the dataset. In some implementations, the one or more circuits can generate, using the machine-learning model and the at least one log, a second command to restart at least one node of the network system.

In some implementations, the one or more circuits can identify a subset of the set of logs corresponding to operation of the network system during a predetermined time period. In some implementations, the one or more circuits can generate, using the machine-learning model and the subset, a summary of the operation of the network system during the predetermined time period. In some implementations, the one or more circuits can update the machine-learning model based at least on a historical service ticket and a corresponding solution identified in a data source corresponding to the network system.

At least one aspect relates to a system. The system can include one or more processors. The system can identify a plurality of network logs corresponding to at least one historical service ticket of a network system. The system can generate a training dataset using at least one of the plurality of network logs or the at least one service ticket. At least one training example of the training dataset can indicate log data indicative of a network anomaly of the network system and a natural language response indicating a resolution to the network anomaly. The system can update/train, using the training dataset, a language model to generate natural language output corresponding to input network logs. The system can cause control of at least one network node of the network system to address a network anomaly indicated in an input network log of the input network logs.

In some implementations, the system can update/train, using the training dataset, the language model to generate the natural language output corresponding to the input network logs in response to natural language queries. In some implementations, the system can update, using the training dataset, the language model to generate commands for at least one external system based at least on the input network logs. In some implementations, the system can generate the training dataset to include a training example comprising at least a portion of a dataset corresponding to the log data.

In some implementations, the system can update/train the language model using the training example to generate the resolution to the network anomaly according to the dataset. In some implementations, the plurality of network logs further comprise at least one annotation relating to the at least one network anomaly, and wherein the training dataset is generated further based on the at least one annotation. In some implementations, the system can update/train the language model to generate instructions to control at least one network node of the network system.

At least one aspect is related to a method. The method can include classifying, using one or more processors, at least one log of a set of logs produced by a network system as corresponding to a network anomaly. The method can include, generating, upon classifying the at least one log as corresponding to the network anomaly, using the one or more processors and a machine-learning model and the at least one log, a command to produce a message comprising natural language output identifying the network anomaly. The method can include causing performance of one or more maintenance actions on the network system based on the message to address the network anomaly.

In some implementations, the natural language output further identifies a potential solution for the network anomaly. In some implementations, the method can include generating, using the one or more processors, based at least on the command, a service ticket identifying the network anomaly and the potential solution for the network anomaly. In some implementations, the method can include transmitting, using the one or more processors, the command to at least one external system associated with the network system.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a large language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for automated network infrastructure diagnostic operations using generative artificial intelligence are described in detail below with reference to the attached drawing figures, wherein:

FIG. 1 is a block diagram of an example system for implementing automated network infrastructure diagnostic operations using generative artificial intelligence, in accordance with some embodiments of the present disclosure.

FIG. 2 is a dataflow diagram showing an example process for generating actions according to prompts for a language model, in accordance with some embodiments of the present disclosure.

FIG. 3 is a flow diagram of an example of a method for implementing automated network infrastructure diagnostic operations using generative artificial intelligence, in accordance with some embodiments of the present disclosure.

FIG. 4A is a block diagram of an example generative LLM system suitable for use in implementing some embodiments of the present disclosure.

FIG. 4B is a block diagram of an example generative LLM that includes a transformer encoder-decoder suitable for use in implementing some embodiments of the present disclosure.

FIG. 4C is a block diagram of an example generative LLM that includes a decoder-only transformer architecture suitable for use in implementing some embodiments of the present disclosure.

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

This disclosure relates to systems and methods for implementing diagnostic operations in large networks/systems, such as telecommunications networks, cable networks, fiber optic networks, water distribution systems, heating, ventilation and air conditioning systems, sewerage management systems, security systems, or power/electrical/energy systems, using machine-learning models. Conventional network/system diagnostic operations rely on detecting specific errors or metrics using hardcoded, rule-based systems. Such approaches have limited context and require manual intervention when issues are detected. Moreover, typical approaches only provide indications of said specific errors or potentially abnormal metrics without offering any type of context for why those errors or metrics have occurred.

These issues are particularly challenging in larger systems such as telecommunications networks, which generate up to billions of log entries per day, each of which may indicate a potential failure or system abnormality. Conventional approaches therefore struggle to efficiently identify and manage indications of failures, errors, or abnormalities at large scales, resulting in increased network downtime or degraded performance. Both the volume and complexity of log information make it challenging to detect and rectify problems in such large network/system infrastructures.

The system and methods described herein provide techniques to efficiently identify and process indications of actual and/or potential abnormalities in large network/system infrastructures, including large telecommunications infrastructures. To do so, log data ingested from devices of a large network/system infrastructure is scanned and classified as potentially corresponding to an anomaly, error, or unexpected condition. Identified log data that is classified as potentially anomalous is provided as input to a generative machine-learning model(s), such as a variant of a large language model, for further classification and processing.

In one illustrative embodiment, the generative machine-learning model may be trained/updated using datasets derived from a telecommunications network, such that the model can automatically identify and generate potential resolutions for the detected network issue. Data used to train/update the machine-learning model may include manuals, industry-standard documentation, textbook data, among other information relevant to a particular network infrastructure.

The machine-learning model may be trained/updated to automatically perform actions in response to detecting certain network conditions. For example, the machine-learning model may generate an output that causes service tickets associated with certain network devices to be generated. Other actions that may be performed by the machine-learning model include automatic generation of emails, messages, or notifications directed to different systems. The machine-learning model can be trained/updated to initiate a service call in the event of a particularly severe failure, by automatically directing a service technician to a location identified as related to the detected network issue.

The generative machine-learning model may also be trained/updated as a language model that is capable of processing and producing natural language for technicians or users. For example, the machine-learning model can receive messages/queries from users or technicians relating to network conditions or network devices. In response, the machine-learning model can produce responses in natural language that includes answers to said queries, with reference to particular network conditions or related log information.

The machine-learning model may also receive/retrieve information from a knowledge base or other data source that includes network information, such as network diagrams/descriptions, network device manuals or documentation, or previous solutions/closed tickets generated by service technicians. The machine-learning model can access the knowledge base or data source to retrieve relevant information to address input queries from technicians or users. These approaches enable for computationally efficient and improved techniques for detecting and addressing network abnormalities in large telecommunications networks.

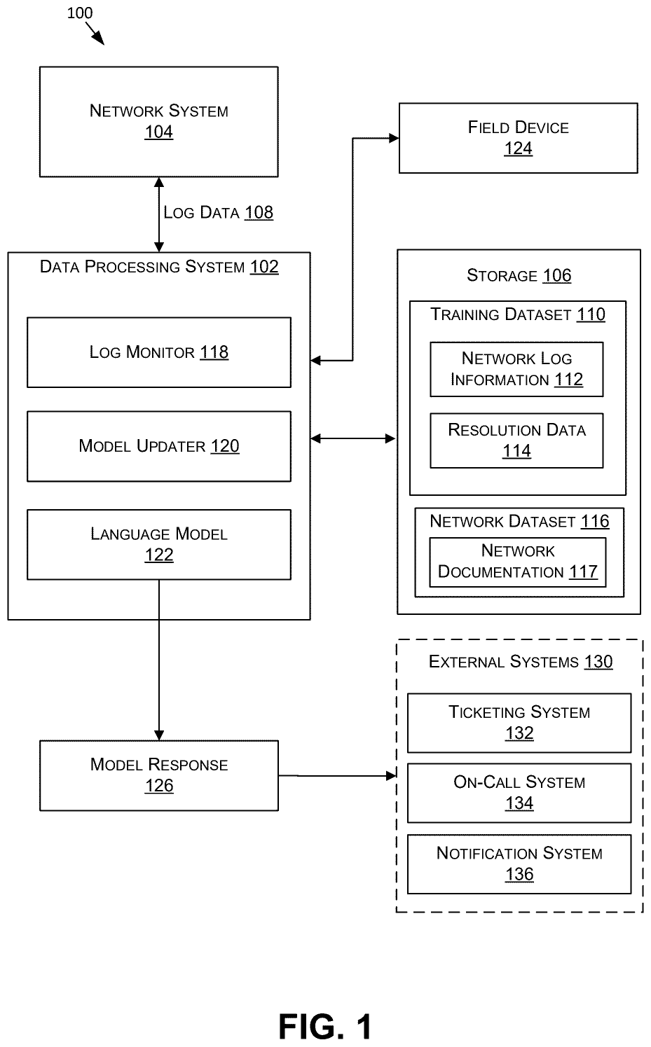

With reference to FIG. 1, FIG. 1 is an example computing environment including a system 100 for implementing automated network infrastructure diagnostic operations using generative artificial intelligence, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 is shown as including a data processing system 102, a network system 104, storage 106, one or more field device(s) 124, and one or more external system(s) 130. The data processing system 102 can store, maintain, or otherwise execute a language model 122. The data processing system 102 can execute a model updater 120 to update/train the language model 122 according to the techniques described herein. The data processing system 102 can execute a log monitor 118 to monitor log data 108 produced by the network system 104 as described herein.

The storage 106 can store one or more training datasets 110, which may include training/update examples that include network log information 112 and resolution data 114 that includes an indication of one or more corresponding resolutions or actions corresponding to the network anomaly. The storage 106 can store a network dataset 116, which can include data or information relating to the network system 104 that is accessible to the data processing system 102 and/or the components thereof. The network dataset 116 may be or include a “knowledge database,” which can include information, documentation, or diagnostic instructions for devices and systems within the network system 104. In this example, the network dataset 116 is shown as including network documentation 117. The network documentation 117 can include hardware manuals, historical service tickets, datasheets, troubleshooting guides, or other documentation relating to any routers, switches, firewalls, and other network equipment of the network system 104. The external systems 130 can include any number of systems that process model response(s) 126 generated by the language model 122 as described in further detail herein. The external systems 130 are shown as including, but not limited to, a ticketing system 132, an on-call system 134, and a notification system 136.

The data processing system 102 can include one or more processors, circuits, memory, and/or computing devices/systems that can perform the various techniques described herein. The data processing system 102 can be implemented, for example, in a cloud computing environment, which may maintain, update/train, and/or execute one or more language models 122, which may be trained/updated according to the techniques described herein to generate output identifying potential resolutions or explanations or detected network anomalies in the network system 104. The data processing system 102 can implement the various techniques described herein to train/update a language model 122 to learn to extract, process, or interpret log data 108 to generate commands (e.g., as part of the model response 126) for one or more external systems 130 to alert or resolve a network anomaly detected in the network system 104.

The network system 104 can be any type of telecommunications network, including but not limited to broadband networks, cellular networks, edge networks, or combinations thereof. In some implementations, the network system 104 may be or include a public switched telephone network (PSTN), an integrated services digital network (ISDN), or a switched packet network. In some implementations, the network system 104 may include a wireless local area network (WLAN), a metropolitan area network (MAN), a wide area network (WAN), the internet, or a combination thereof. The network system 104 can include a hybrid fiber coaxial (HFC) network, which uses both optical fibers and coaxial cables to provide broadband internet access to subscribers, or a cable network. The network system 104 can also include various devices and components such as routers, switches, firewalls, servers, modems, base stations, access points, repeaters, amplifiers, multiplexers, demultiplexers, bridges, gateways, hubs, concentrators, and other networking equipment. Additionally, the network system 104 may be a hybrid network that combines different types of networks, such as a wired-wireless network or a fiber-optic-copper cable network. The devices and components in the network system 104 can communicate with each other using various protocols.

The network system 104 (or any components, devices, or systems thereof) can generate log data 108 (sometimes referred to herein as “network log(s) 108”), which can be received or otherwise accessed by the data processing system 102. The log data 108 may include various types of data generated by devices and components operating within the network system 104, such as router logs, switch logs, firewall logs, server logs, modem logs, base station logs, access point logs, repeater logs, amplifier logs, multiplexer logs, demultiplexer logs, bridge logs, gateway logs, hub logs, concentrator logs, and other types of log data. For example, the network system 104 may produce a router log that includes information about packet routing decisions made by routers within the network, such as source IP addresses, destination IP addresses, protocol type (e.g., TCP/IP), port numbers, packet sizes, transmission times, and error rates. The network logs 108 can also include security-related data, such as intrusion detection system (IDS) alerts, intrusion prevention system (IPS) blocks, antivirus scan results, malware detection reports, and other types of security event information. Additionally, the network logs 108 may contain performance metrics, such as bandwidth usage statistics, packet loss rates, latency measurements, jitter values, and throughput data, which can be used to monitor and optimize network performance.

For example, the log data 108 can include various metrics corresponding to network telemetry of the network system 104, such as packet loss rates, latency measurements, jitter values, throughput statistics, and bandwidth usage information. For example, the log data 108 may include router logs that track the number of packets transmitted per second, the average round-trip time (RTT) for each packet, and the percentage of packets lost or corrupted during transmission. The log data 108 can also include switch logs that monitor utilization rates, error rates, and broadcast storm activity. Additionally, the log data 108 may contain firewall logs that track incoming and outgoing traffic by protocol type, source IP address, destination IP address, and port number, in some implementations. In some implementations, the log data 108 can include information identifying computer resource usage, memory utilization, or application response times, which can be used to identify performance bottlenecks or potential security threats of various devices in the network system 104.

In some implementations, the log data 108 can include various information that may be used to diagnose anomalies detected in the network infrastructure of the network system 104. For example, the log data 108 may include information about device failures such as device crashes, errors, or disconnections, which can indicate potential hardware issues affecting network performance or operation. Additionally, the log data 108 can include metrics related to traffic congestion and overload conditions, such as high packet loss rates, excessive latency, or buffer overflow events, which can indicate network capacity planning problems or configuration issues. Furthermore, the log data 108 may contain information about security breaches, including unauthorized access attempts, malware infections, or denial-of-service (DoS) attacks, which can help identify potential vulnerabilities in the network infrastructure and inform remediation efforts.

The data processing system 102 can receive or otherwise access the log data 108 by communicating with one or more devices of the network system 104. In some implementations, the log data 108 may be received or retrieved from multiple devices or components of the network system 104. The log data 108 can be accessed periodically or according to an access schedule. For example, the data processing system 102 may receive log data 108 directly from network devices (e.g., routers, switches, etc.) via a Simple Network Management Protocol (SNMP) query or retrieve logs from switches using a suitable protocol (e.g., a NetFlow protocol, etc.). Additionally, the data processing system 102 may access or otherwise receive log data 108 from various software components executing on devices of the network infrastructure, such as diagnostic monitoring programs, firewalls, and intrusion detection systems (IDSs), through APIs or other interfaces. In some implementations, the data processing system 102 can access log data 108 stored in databases or files on devices such as servers, modems, base stations, and access points using a suitable communication protocol.

The data processing system 102 can execute a log monitor 118 to monitor log data 108 generated by the network system 104. The log monitor 118 processes the log data 108 using various techniques, including deep learning-based anomaly detection algorithms, rule-based detection approaches, or other anomaly detection techinques to identify potential security threats or irregularities in the network traffic of the network system 104. In some implementations, the log monitor 118 can execute one or more artificial intelligence models (e.g., neural network model(s), etc.) that is trained/updated on a dataset of normal and anomalous logs to classify incoming log data 108 into one of these two categories. In some implementations, the neural network model may be fine-tuned/updated using transfer learning techniques to adapt to specific patterns and characteristics of a specific network system 104.

In some implementations, log monitor 118 can apply one or more rule-based approaches to detect patterns or trends in the log data 108 over time. For example, the log monitor 118 can identify changes in network traffic volume, packet sizes, or communication protocols that may be indicative of network anomalies or malicious activity. In some implementations, the log monitor 118 can leverage statistical process control (SPC) methods to identify deviations from normal operating conditions and can flag potential issues within the network system 104.

In some implementations, the log monitor 118 can use one or more rules to analyze log data 108. For example, the log monitor 118 may match specific patterns or keywords in the logs corresponding to known anomalies. Network anomalies may correspond to any abnormal or suboptimal operation of the network system 104 and may be indicated explicitly in the log data 108 or implicitly by comparing expected performance values with thresholds corresponding to various network anomalies.

The log monitor 118 can flag any network logs in the log data 108 that are classified as corresponding to a network anomaly. The data processing system 102 can use the flagged network logs in connection with the language model 122, as described in further detail herein, to generate natural language responses and/or commands (e.g., as part of the model response(s) 126) for resolving the network anomaly. In some implementation, the log monitor 118 can store any flagged network logs of the log data 108 in one or more timestamped data structures, either locally within or remotely from the data processing system 102.

The data processing system 102 can access the flagged network logs to process using the language model 122. The language model(s) 122 may be or include a transformer-based model (e.g., a generative pre-trained transformer (GPT) model). The language model(s) 122 may be or include a large language model (LLM) or a vision language model (VLM), in some implementations. In some implementations, the language model(s) 122 may use, be or include one or more tokenizers, which are capable of converting input data (e.g., log data 108 classified as potentially corresponding to a network anomaly by the log monitor 118) into an encoded format (e.g., one or more tokens, or a “tokenized” format) that is compatible with the layers of the language model(s) 122.

The language model(s) 122 can include a single language model. In some implementations, the language model 122 can include a mixture of experts (MoE) language model. A MoE model consists of an ensemble of expert models, each responsible for modeling a specific aspect or domain of knowledge. The expert models are trained on different subsets of the training data and are designed to specialize in their respective domains. During inference, the input is routed to the most relevant expert model based on the data with which it was trained/updated, which generates output that is then combined with outputs from other models in the MoE using a gating network.

The language model(s) 122 can be trained/updated using one or more training datasets 110, as described in further detail herein, to generate model responses 126 based on input network log data. The model response(s) 126 can include commands, instructions, natural language prompts or indications of network anomalies, natural language prompts or indications of resolutions to network anomalies, or combinations thereof. For example, the model responses 126 may include commands for one or more external systems 130 to transmit notifications to one or more computing devices such as field device 124.

In this example, the external systems 130 are shown as including a ticketing system 132. In some implementations, a model response 126 can include a command for the ticketing system 132 with instructions to generate one or more service tickets. The ticketing system 132 can generate service tickets corresponding to different network anomalies reflected in the model response 126, which may include natural language output from the language model 122. For example, if the log data 108 provided as input to the language model 122 indicates that a specific device of the network system 104 is experiencing an error or an irregular state, the model response 126 can include instructions for the ticketing system 132 to generate a service ticket with instructions to investigate or resolve the anomaly corresponding to the device.

The external systems 130 are shown as including an on-call system 134. The on-call system 134 can be a system responsible for transmitting notifications of network failures or anomalies to field agents that perform maintenance on the network system 104. The on-call system 134 may include any number of circuits, processors, servers, or computing systems that receive indications or instructions, and generate corresponding notifications for transmission to one or more field agent devices (e.g., a field device 124). In some implementations, the on-call system 134 can transmit an indication to the ticketing system 132 to generate one or more service tickets based on the instructions in the model response 126. In one example, a model response 126 can include instructions for the on-call system 134 to alert one or more field agents of a network failure. The instructions can cause the on-call system 134 to transmit notifications that include a natural language summary of the network failure and identifier(s) of the network device(s) of the network system 104 corresponding to the failure. Instructions for the on-call system 134 can be generated by the language model 122 as part of the model response 126, for example, when a severity of a network anomaly is detected to satisfy a predetermined condition or severity.

The external systems 130 are shown as including a notification system 136. The notification system 136 can be a system that can transmit notifications corresponding to network anomalies to one or more end-users of the network system 104. The notification system 136 may include any number of circuits, processors, servers, or computing systems that receive indications or instructions, and generate corresponding notifications for transmission to client devices. Such notifications can be transmitted via e-mail, short messaging service (SMS) messages, push notifications, any other type of notification that can be transmitted or otherwise provided to an end-user. In one example, a model response 126 can include instructions for the notification system 136 to transmit one or more notifications to end-users that may experience degradation of network performance due to a network anomaly. The instructions can cause the notification system 136 to transmit notifications that include a natural language summary of the network failure or an indication of an amount of time to address or resolve the network failure.

In some implementations, the language model 122 may generate instructions for the data processing system 102 to access information in the network dataset 116. In some implementations, the language model 122 may generate instructions for the data processing system 102 to access information in the network dataset 116. The network dataset 116 and/or the network documentation 117 can include, but is not limited to, network diagrams and descriptions of the network architecture of the network system 104, user manuals and documentation for devices and systems within the network system 104, previous interactions with users or other external systems, anomaly resolutions and troubleshooting guides, service tickets and incident reports, configuration files and settings for routers, switches, firewalls, and other network equipment, and historical data on network performance metrics such as packet loss rates, latency, and throughput, among other information.

In some implementations, the data processing system 102 or the ticketing system 132 can automatically update the network dataset 116 with an indication of a resolution for a network anomaly in response to detecting that a service ticket for the network system 104 has been resolved. For example, upon resolving a service ticket related to a router configuration issue, the data processing system 102 may extract information from the ticket notes such as the specific configuration changes made to resolve the issue, the affected devices or systems, and any relevant troubleshooting steps performed to resolve the network anomaly. As this data is stored in the network dataset 116, natural language descriptions of proposed solutions to similar network anomalies can be generated using the language model 122.

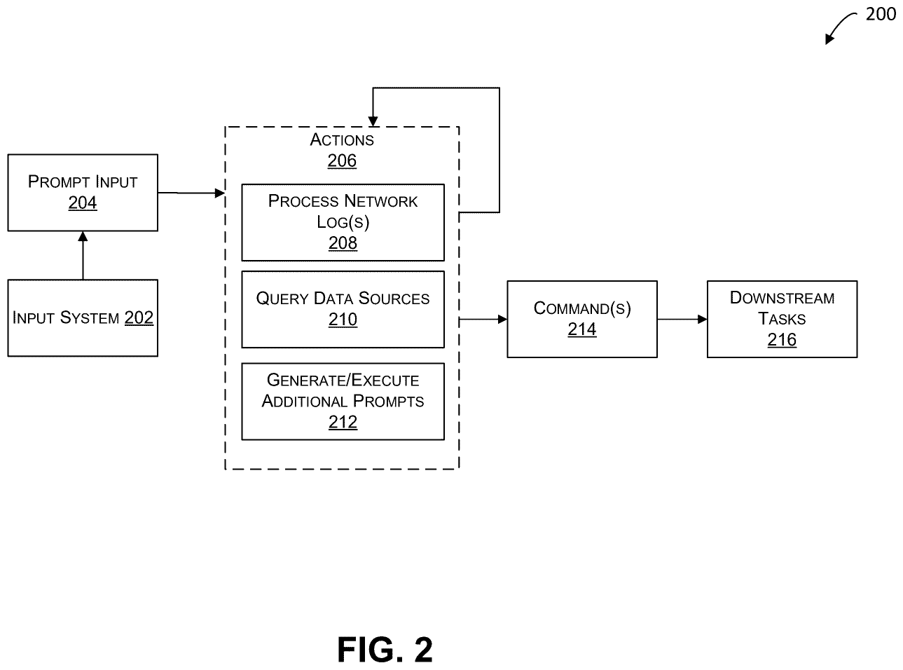

In some implementations, commands generated by the language model 122 can include commands to retrieve data relating to a detected anomaly from the network dataset 116. For example, a suitable search function, such as a vector search function, can be implemented to retrieve any relevant documents, past interactions, or information relating to one or more detected anomalies or related network devices/systems. Information retrieved from the network dataset 116 can be provided as input to the language model 122 to generate a second model response 126 with one or more further commands for a field device 124 or one or more external systems 130. The second response may include a natural language summary of the network anomaly and information retrieved from the network dataset 116, in some implementations. Further details relating to instructions or natural language output generated by the language model 122 are described in connection with FIG. 2.

In some implementations, the data processing system 102 can provide one or more commands to components, systems, or devices of the network system 104. For example, in some implementations one or more model responses 126 can include commands to configure, initialize (e.g., boot, restart, etc.), or otherwise control one or more devices of the network system 104. Such commands may be provided to address a detected anomaly in the network system 104. Configuring a component/device of the network system 104 can include updating software, firmware, and/or configuration settings of the component/device by communicating corresponding data to the component/device. In some implementations, upon transmitting a command to control or configure the component/device of the network system 104, the data processing system 102 can transmit one or more messages to one or more devices/components of the network system 104, or monitor the performance of any aspect of the network system 104, to determine whether the network anomaly has been resolved.

In some implementations, if the network anomaly has been resolved, the data processing system 102 can execute the language model 122 to generate further natural language output indicating the network anomaly and any automatic steps performed to resolve the network anomaly. In some implementations, if controlling or otherwise configuring the component/device is determined not to have resolved the network anomaly, the data processing system 102 can execute the language model 122 to generate a natural language response indicating that the network anomaly is still present, and the automatic steps taken that attempted to resolve the network anomaly. These natural language outputs may be provided to one or more field devices 124 and/or one or more external systems 130, as described herein.

The data processing system 102 can, in some implementations, use the language model 122 to generate natural language summaries of the operations of the network system 104 over one or more periods of time. The natural language summaries may be summaries of any detected anomalies, performance metrics, or other indications of network performance, and may be provided to one or more operators of the network system 104 (e.g., via one or more field devices 124 and/or one or more external systems 130). The time period may be specified via one or more configuration settings of the data processing system 102 or may be specified or configured via messages transmitted from at least one field device 124 and/or one or more external systems 130.

The language model 122 can be used to process natural language queries from one or more field devices 124. For example, field devices 124 can receive natural language prompts provided by field technicians of the network system 104. The natural language prompts may include indications of network anomalies, requests for information relating to one or more devices/components of the network system 104, and/or requests for information from the network dataset 116, among others. The field devices 124 can transmit the natural language prompts to the data processing system 102, which can provide the prompts as input to the language model 122.

The data processing system 102 can execute the language model 122 to generate a corresponding model response 126, as described herein, which may include natural language output corresponding to the input prompt. In some implementations, the data processing system 102 can retrieve information from the network dataset 116 to generate the model response 126, as described herein. For example, if the natural language prompt requests information about a particular network device, the data processing system 102 can search the network dataset 116 to retrieve relevant documentation (e.g., identified via one or more searching functions as described herein) for input to the language model 122.

Additional prompts may be provided to the language model 122 by the field device(s) 124, such that the language model 122 is used to implement a conversational agent. Records of prior prompts, as well as responses and additional contextual data retrieved or generated by the data processing system 102 can be stored in association with identifier of a communication session between the data processing system 102 and the corresponding field device 124. In some implementations, the communication session may be stored in association with an identifier of a service ticket corresponding to a detected network anomaly, which may be selected or otherwise indicated by a field device 124, in some implementations.

In this example, the data processing system 102 is shown as being in communication with one or more field devices 124. A field device 124 can be any type of device that may be used by a network operator or field agent that maintains the network system 104. For example, the field device(s) 124 can include any type of device that is capable of communicating with the data processing system 102 (e.g., via a network), including but not limited to smartphones, laptop or mobile computers, augmented and/or virtual reality devices, digital assistant devices, accessibility devices (e.g., hearing aids or equipment, etc.) personal computers, servers, cloud computing systems, or other types of computing systems that can provide input to the data processing system 102 for use in connection with the language model 122. A field device 124 may include one or more input/output device(s), such as microphones, video/image capture devices (e.g., integrated cameras), and text input devices (e.g., touchscreens, keyboards, etc.).

A field device 124 can be operated to provide one or more input prompts (or portions thereof) to the language model 122. In some implementations, the data processing system 102 can provide one or more model responses 126 to a field device 124 in response to corresponding prompt. For example, the field device 124 may receive user-input relating to a particular network device of the network system 104. In response to the prompt, the language model can generate a model response 126 including a natural language output providing requested information relating to the device (e.g., accessed from log data 108, by searching the network dataset 116, etc.). In another example, the input may include a natural language prompt requesting information relating to a status of the network system 104 or any significant events or changes that occurred in the network system 104 during a period of time (e.g., a previous day, night, week, etc.). In response to the prompt, the language model can generate a model response 126 including a natural language output providing requested information relating to the device (e.g., accessed from log data 108, by searching the network dataset 116, etc.).

The data processing system 102 can execute a model updater 120 to update/train/fine-tune the language model 122 to perform any of the functionality described herein. To do so, the data processing system 102 can access the storage 106 to identify and/or generate one or more training datasets 110 for updating/training/fine-tuning the language model 122. As shown, in this example, the data processing system 102 is in communication with the storage 106. The storage 106 may be an external server, distributed storage/computing environment (e.g., a cloud storage system), or any other type of storage device or system that is in communication with the data processing system 102. Although shown as external to the data processing system 102, it should be understood that the storage 106 may form part of, or otherwise be internal to, the data processing system 102. Although shown here as including the network dataset 116, it should be understood that in some implementations the network dataset 116 may be stored via a different storage system than the storage 106, which stores generated training datasets 110.

The data processing system 102 can execute a model updater 120 to update/train/fine-tune the language model 122 using a training dataset 110 to perform any of the functionality described herein. The training dataset 110 can be generated to include one or more training/update examples for training/updating/fine-tuning the language model 122. The training/update examples can include an input prompt for the language model 122 paired or otherwise associated with a corresponding output prompt for the language model, such as “What is the cause of network anomaly X?” and “The root cause of network anomaly X is due to faulty router Y.” In addition, the training dataset 110 may also include other types of examples, including but not limited to: “What are the possible causes of packet loss on a specific network segment?”, “Why did the network connection drop at time T?”, or “How can I troubleshoot a slow network performance issue?” The language model 122 is trained/updated using these training/update examples to learn how to extract, process, and interpret log data from various types of end-user computing devices that field device 124 may include.

To generate the training dataset 110, the data processing system 102 can identify a set of network log information 112 corresponding to at least one historical service ticket of the network system 104. The historical service tickets may correspond to previously resolved network anomalies in the network system 104. The data processing system 102 can identify the set of network log information 112 by accessing a record of historical resolved network issues/anomalies (e.g., in historical service tickets, etc.) stored in in the network dataset 116. The network dataset 116 may include various data records that include natural language text describing detected network anomalies and corresponding resolution data 114 for said network anomalies. The service tickets may include records of troubleshooting tasks taken to identify and resolve network anomalies in the network system.

In one example, the data processing system 102 can query the network dataset 116 using specific keywords or search criteria (e.g., “network outage”, “packet loss”, “router failure,” other network anomalies, etc.) to identify historical service tickets that indicate network anomalies in the telecommunications network. The identified service tickets may include detailed information about any detected anomalies, such as timestamps, device/component identifiers, and error messages, which can be used to train the language model 122 to recognize patterns and relationships between different types of network anomalies and their corresponding resolution data 114. The network log information 112 retrieved from the network dataset 116 may include records indicating network outages due to hardware failures (e.g., faulty routers or switches), software bugs causing packet loss or corruption, misconfigured firewalls or intrusion detection systems, or any other type of anomaly/issues that impacts performance or availability of the network system 104.

The data processing system 102 can generate a training/update example for the training dataset by including a natural language prompt indicating the network anomaly identified from the network log information 112 (e.g., which may be extracted from a corresponding service ticket), and a corresponding resolution indicated in resolution data 114 extracted from the historical service ticket. In some implementations, the network anomaly can be identified based on at least one annotation in the network log information 112, which may be extracted from a historical service ticket or from another data source having information relating to one or more historical anomalies resolved in the network system 104. The resolution data 114 include a natural language output identifying steps or actions to resolve the network anomaly, which may be generated according to information in the historical service ticket. The resolution data 114 may be extracted from any data entries in the network dataset 116 that indicate how the network anomaly in the historical service ticket was resolved. Examples of resolutions indicated in resolution data 114 may include but are not limited to replacing a failed router with a new one, updating the firmware on a switch to fix a bug, reconfiguring firewall rules to allow traffic flow, or troubleshooting and resolving software bugs causing packet loss.

In some implementations, resolution data 114 can include natural language output identifying steps or actions to resolve the network anomaly identified in the historical service ticket. In some implementations, the language model 122 can be executed to generate supplement sparse resolutions with additional detail by generating a comprehensive summary for a resolution of the network anomaly indicated in the historical service ticket. In some implementations, the data processing system 102 can classify and extract resolution data 114 from historical service tickets using natural language processing techniques, such as named entity recognition (NER) to identify specific device names or technical terms, part-of-speech tagging to determine the grammatical context of each sentence, and dependency parsing to analyze the relationships between different components in a service ticket. In some implementations, the data processing system 102 can execute the language model 122 (which may be a pre-trained language model) to extract or otherwise automatically identify text data in a historical service ticket that corresponds to information relating to or a resolution for a corresponding network anomaly.

The data processing system 102 can generate one or more training/update examples for the training dataset 110 that include network log information 112, formatted to as an input prompt for the language model 122, and corresponding resolution data 114, formatted as a natural language output to be generated by the language model 122 that indicates a resolution to at least one network anomaly identified in the corresponding network log information 112. The network log information 112 may include log data 108 (or information extracted therefrom) associated with one or more historical service tickets for the network system 104.

The resolution data 114 may include any type of natural language output, as described herein, that indicates the network anomaly and any steps to be performed to identify, troubleshoot, or otherwise resolve the network anomaly. In some implementations, the resolution data 114 may include instructions for the data processing system 102, one or more external system(s) 130 (e.g., the ticketing system 132, the on-call system 134, the notification system 136, etc.), and/or one or more components/devices of the network system 104. For example, in some implementations, if the type of network anomaly can be resolved by a field technician, the data processing system 102 can generate the resolution data 114 to include corresponding instructions for the on-call system 134 to initialize a service request for the network system 104, as described herein. Similarly, the resolution data 114 can include instructions for the ticketing system 132 to automatically generate service tickets for network issues/anomalies indicated in the corresponding network log information 112 and/or the notification system 136 to transmit notifications to one or more users of the notification system, as described herein.

In some implementations, the network log information 112 can be supplemented with additional information retrieved from the network dataset 116, and/or retrieved from the network dataset 116 and/or the network documentation 117. As described herein, the data processing system 102 can retrieve information relating to one or more network logs 108 from the network dataset 116 to provide further context for addressing any detected network anomalies. To train/update the language model 122 to utilize this information, training/update examples can be generated as part of the training dataset 110 to include additional contextual information retrieved from the network dataset 116. To generate such training/update examples, the data processing system 102 can search the network dataset 116 using the corresponding network log information 112 to identify resolution data 114 corresponding to an anomaly indicated in the network log information 112. In some implementations, a different language model (e.g., accessible via one or more application programming interfaces (APIs) may be used to summarize or otherwise process the data identified from the network dataset 116 for inclusion in the resolution data 114 of the training/update example.

In some implementations, the resolution data 114 can include instructions to control at least one network node, device, and/or component of the network system 104. Controlling the node, device, and/or component can include configuring, resetting, or causing the node, device, and/or component to perform one or more actions or operations. The instructions can be generated using information indicated in the network dataset 116 (e.g., documentation indicating commands to perform various actions for different anomalies), in some implementations. In some implementations, the resolution data 114 can include instructions to cause the data processing system 102 to perform one or more operations, including but not limited to retrieving information from the network dataset 116, for example, to provide more context for addressing a network anomaly or controlling devices/components of the network system 104.

Generating the training dataset 110 can include generating training/update examples to provide information relating to the network system 104 in response to natural language requests from one or more operators or field agents. Such training/update examples can include pairs of input prompts to be provided as input to the language model 122 and output responses to be generated by the language model 122. The responses may be extracted or generated from information in the network dataset 116, which may be identified from historical records of requests, prompts, or questions indicated in historical service tickets or other sources of electronic information (e.g., e-mails, chat messages, etc.). In some implementations, the data processing system 102 can generate multiple training datasets 110, with each training dataset 110 having a respective training objective.

The data processing system 102 can maintain, execute, and train/update one or more language models 122 using the model updater 120. The language model(s) 122 can include any type of multimodal language model capable of processing natural language text input, audio input, video input, or image input, among other media modalities. The language model(s) 122 may be or include a transformer-based model (e.g., a generative pre-trained transformer (GPT) model). The language model(s) 122 may be or include a large language model (LLM) or a vision language model (VLM), in some implementations. In some implementations, the language model(s) 122 may use, be or include one or more tokenizers (e.g., tokenizer models), which can convert media data into an encoded format (e.g., one or more tokens, or a “tokenized” format) that is compatible with the layers of the language model(s) 122.

Although shown as storing a single language model 122, in some implementations the data processing system 102 can maintain, store, or update multiple language models 122. For example, different language models 122 may include different media processing capabilities (e.g., one language model 122 can process video data, another language model 122 model can process audio and text data, etc.). In some implementations, different language model(s) 122 can be trained/updated according to different training/update objectives by using one or more corresponding training dataset(s) 110.

The data processing system 102 can use the model updater 120 to train/update a language model 122. The language model 122 may be trained/updated, in one example, in response to a corresponding request received from an external computing device or in response to input received from an operator of the data processing system 102. The model updater 120 can include any software, hardware, or combinations thereof to perform training/update operations of the language model(s) 122 as described herein. The request to train/update the language model 122 may indicate one or more training datasets 110 to use in training/updating the language model(s) 122. In some implementations, the training datasets 110 can be automatically identified or otherwise selected based on one or more training/update objectives specified in the request (e.g., by selecting training datasets 110 having a training/update objective that matches that specified in the request, etc.).

To train/update a language model 122 using a training dataset 110, the model updater 120 can iterate through each training/update example in the training dataset 110 according to hyperparameters (e.g., number of epochs, batch size, etc.) of the training/update process, which may specified via the request to train/update the language model 122 or via configuration settings. For each training/update example, the model updater 120 can generate a context for the language model 122 to be trained. Generating the context can include converting the data of the training example into a tokenized format (e.g., using a tokenizer model corresponding to the language model). The tokenized format can be a numerical format that encodes the text data in the training/update example and is compatible with one or more input layers of the language model 122.

Generating the context may include concatenating tokenized input data (e.g., the network log information 112, any additional contextual data or input prompt information, etc.) with encoded output data (e.g., tokenized resolution data 114) into a sequence. Different tokens can designate the start and end of different portions of the sequence to differentiate the input prompt and the output response. In some implementations, positional encodings or other relevant embeddings can be added to the context to preserve the order of certain input/output data in the sequence, and to differentiate between the input and output segments of the context.

In a training/update iteration, the model updater 120 can execute the language model 122 by passing the sequence of encoded data of the context through each layer of the language model 122 while performing mathematical/machine-learning operations of each layer. The output of the language model 122 can include a distribution of candidate token outputs, from which one or more output tokens are selected. The output can be predicted autoregressively, in some implementations, where the model updater 120 appends the predicted output token to the initial context to generate an extended context. The extended context is then provided as input to the language model 122 until each of the output tokens have been predicted. In some implementations, a “teacher forcing” technique can be used, in which the ground truth tokens from the output portion of the context sequence (rather than the model's own predictions) are appended to the initial input context for predicting the next token. In some implementations, the language model 122 may generate tokens non-autoregressively, where the language model 122 is executed to predict all tokens of the output simultaneously.

The model updater 120 can compare the ground truth tokens of the training/update examples to each output token predicted by the language model 122 using a loss function, such as a cross-entropy loss function, to quantify the difference between the predicted and actual tokens. In one example where cross-entropy loss is used, the model updater 120 can compare the predicted probability distribution (e.g., the softmax function) output by the language model 122 to a one-hot encoded true distribution representing the actual next token(s) in the output sequence. The model updater 120 can calculate the cross-entropy loss as the negative log probability of the ground truth token according to the predicted distribution of the language model 122. The model updater 120 can calculate the total loss for the training/update sequence as the sum (or some implementations, the average) of the cross-entropy losses over all token positions in the output sequence predicted by the language model 122. Similar approaches may be used to calculate other types of loss functions, in some implementations.

The model updater 120 can use backpropagation techniques to train/update the parameters of the language model 122 using the computed loss. Backpropagating can involve calculating gradients of the loss with respect to each parameter and adjusting the parameters in the direction that minimizes the loss. Parameter adjustment can be performed using a suitable optimization function, such as a gradient descent function or an Adam optimizer function. The model updater 120 can iteratively repeat this process with a number of training/update examples of the training dataset(s) 110 until a training/update termination condition has been reached, such as an accuracy threshold being met or upon using a predetermined number of training/update examples to train/update the language model(s) 122.

Once trained/updated, the language model 122 can be executed to process log data 108 to generate natural language output identifying detected network anomalies and potential responses thereto, as described herein. In some implementations, the language model 122 can be executed iteratively, in which commands/instructions generated by the language model 122 are used by the data processing system 102 to perform additional operations and execute the language model 122 with additional information/contextual information according to the additional operations.

For example, the language model 122 can execute instructions for the data processing system 102 to retrieve additional information relating to a potential network anomaly, a component/device of the network system 104, or attributes (e.g., the network architecture, topology, or general data/information, etc.) of the network system 104 from the network dataset 116. This additional data can be provided as input to the language model 122 in a subsequent input prompt (which may include previous prompt/response data) to generate output corresponding to one or more network anomalies of the network system 104. Further details of iterative approaches for executing the language model 122 are described in connection with FIG. 2.

Referring to FIG. 2 in the context of the components described in connection with FIG. 1, illustrated is a dataflow 200 diagram showing an example process for generating actions 206 according to prompts 204 for a language model (e.g., the language model 122), in accordance with some embodiments of the present disclosure. As shown, the process shows an input system 202 providing at least one input prompt 204 to the language model, which generates one or more actions 206 to be performed by system executing the language model (e.g., the data processing system 102). The input system 202 can include any system that can generate data or input for the language model and may include nodes/devices/components of a network system (e.g., the network system 104), devices of field technicians of the network system (e.g., one or more field devices 124), or any other computing system described herein.

The input prompt 204 can be any type of prompt that may be provided as input to the language model—and may include network logs (e.g., log data 108) that is classified as corresponding to network anomalies, a natural language input from a field technician and/or operator of the network system, data retrieved from a dataset storing information relating to the network system (e.g., the network dataset 116), or combinations thereof. The input prompt may be provided as input to the language model and may include an indication of a network anomaly detected in the network system. The network anomaly may be detected, for example, using a monitoring process (e.g., the log monitor 118) that monitors logs generated by nodes/devices/components of the network system, as described herein.

The language model can then be executed to generate output (e.g., one or more model responses 126) that indicate one or more actions 206 to be performed to attempt to resolve or retrieve additional information relating to one or more network anomalies. The actions 206 can include any type of operation that may be performed by the system executing the language model, by external systems (e.g., the external systems 130), and/or by one or more field devices (e.g., a field device 124). In some implementations, an action 206 generated by the language model can include an action to process network logs 208 indicated in or related to an input prompt 204. The action to process network logs 208 can include using the language model to summarize any information relating to a detected network anomaly (e.g., detected by the log monitor 118) indicated in one or more network logs. Summarizing the network anomaly can include generating a natural language summary identifying the network anomaly, any corresponding devices/components/nodes of the network system associated with the network anomaly, and/or one or more potential solutions for the network anomaly, among others. The summary may include any attributes of the network anomaly, including but not limited to a type of anomaly, a time that the anomaly occurred, and any devices/components/nodes of the network system associated with the anomaly, among others.

The language model 122 can be executed to generate output with an action to query one or more data sources 210. As described herein, a dataset associated with the network system (e.g., the network dataset 116) can store information relating to the network system and the components thereof. This information may include documentation, historical service tickets and corresponding resolutions, datasheets/manuals, or network architecture/topology information, among other data. Instructions generated by the language model can indicate that further data (e.g., device information, historical resolutions to similar anomalies, etc.) is to be retrieved to provide context for a detected network anomaly.

Such instructions can cause the system executing the language model (e.g., the data processing system 102) to perform an action to query one or more data sources 210. The action to query one or more data sources 210 can include performing a search function over a data source (e.g., the network dataset 116) corresponding to the network system, with terms, keywords, or identifiers of network components/devices/nodes, identifiers of network anomalies, or other search query components generated by the language model. In some implementations, the search function can be a keyword-matching similarity search. In some implementations, the search function can include a vector search over a vector database.

As shown, in some implementations, the language model can generate instructions to execute further output based on additional prompts generated by the language model. Such instructions can be an action to generate/execute additional prompts 212. One example of an action to generate/execute additional prompts 212 can include generating and executing additional prompts for the language model using data retrieved by querying one or more data sources (e.g., the network dataset 116). In some implementations, an action to generate/execute additional prompts 212 can include executing additional prompts received from an operator/field agent of the network system. For example, the language model may be trained/updated according to the techniques described herein to generate output that requests additional information (e.g., an additional prompt) to be input prior to generating a potential resolution for a network anomaly. Upon receiving additional prompt(s), the language model can generate a natural language response message indicating a network anomaly and/or details relating to resolving or troubleshooting the network anomaly, as described herein.

The language model, when executed, can generate actions 206 to transmit one or more commands to downstream systems (e.g., the external systems 130) to perform one or more downstream tasks 216. The downstream tasks 216 can be performed, for example, by the one or more external systems to initiate service calls, record or update service tickets, and/or alert users of the network system of failures/anomalies/conditions of the network system. For example, the commands 214 can include instructions for a ticketing system (e.g., the ticketing system 132) to generate one or more service tickets. In another example, the commands 214 can include instructions for an on-call system (e.g., the on-call system 134) to initiate one or more service calls for the network system, which may be associated with a respective service ticket, in some implementations. In another example, the commands 214 can include instructions for a notification system (e.g., the notification system 136) to generate and/or transmit one or more notifications to alert users of the network system of the status of the network system, any detected anomalies, and/or service times to resolve a detected network anomaly in the network system.

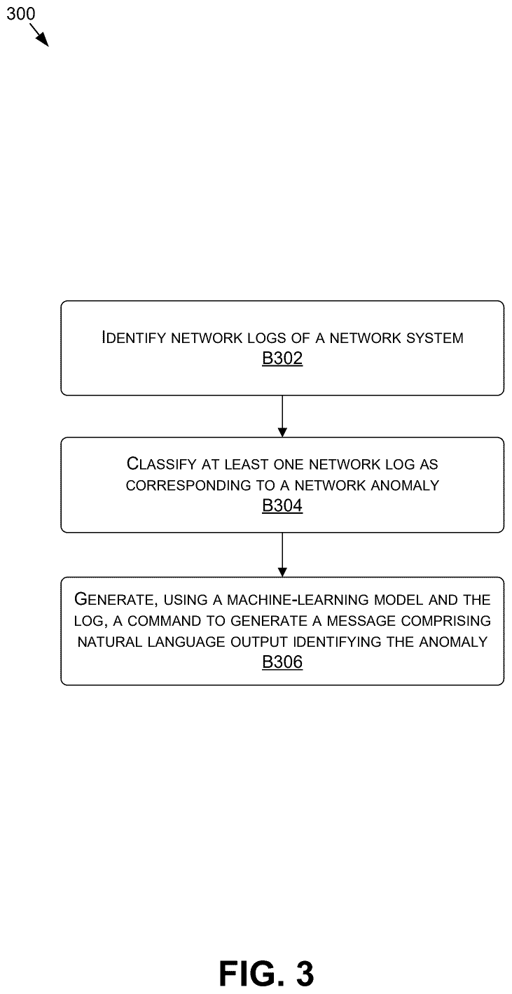

Now referring to FIG. 3, each block of method 300, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for implementing automated network infrastructure diagnostic operations using generative artificial intelligence. The method 300, at block B302, includes identifying network logs (e.g., the log data 108) of a network system (e.g., the network system 104). The network logs may include any data generated by any device, component, node, or sub-system of the network system. The network logs can include operational data, diagnostic information, or other data that may be used to identify or otherwise detect network anomalies. In some implementations, the network logs may include error reports, logs indicating aggregate consumption/congestion of network resources, or any other metric that may be generated by a telecommunications network. In some implementations, the network logs can be identified in response to a request (e.g., from the data processing system 102). In some implementations, the request may be provided via input to the computing system (e.g., the data processing system 102) performing the method 300. In some implementations, the network logs can be accessed according to an access schedule (e.g., periodically, as the logs are generated, according to a batch retrieval process, etc.).

The method 300, at block B304, includes classifying at least one network log as corresponding to a network anomaly. Identified network logs can be processed (e.g., by the log monitor 118, etc.) to identify any logs that include information that is indicative of a network anomaly. In some implementations, rule-based approaches can be used to identify predetermined data or conditions of the network that indicate one or more classes/types of network anomaly. In some implementations, one or more neural network model(s) that are trained/updated on a dataset of normal and anomalous logs can be used to classify incoming log data to detect one or more potential network anomalies. In some implementations, the neural network model may be fine-tuned/updated using transfer learning techniques to adapt to specific patterns and characteristics of a specific network system. In some implementations, changes in network traffic volume, packet sizes, or communication protocols can be used to identify network/system anomalies or malicious activity.

The method 300, at block B306, includes generating, using a machine-learning model (e.g., the language model 122) and the network/system log, a command to generate a message (e.g., a service ticket, an on-call service initiation, a notification, etc.) that includes natural language output identifying the network/system anomaly. Generating the natural language output can include providing data from the classified network/system log(s) as input to the machine-learning model. The natural language output may include one or more summaries of the network/system anomaly, condition(s) of the network system associated with the network/system anomaly, and/or indications of any devices/components/sub-systems associated with the network/system anomaly. In some implementations, the natural language output can include a description of the network/system anomaly and one or more steps to resolve or troubleshoot the network anomaly.

In some implementations, the output of the machine-learning model can include instructions for a ticketing system (e.g., the ticketing system 132) to generate one or more service tickets that include the natural language response. In some implementations, the output of the machine-learning model can include instructions for an on-call system (e.g., the on-call system 134) to initiate a service call for the network system, which may include populating one or more data structures with a natural language description of the network/system anomaly. In some implementations, the output of the machine-learning model can include instructions for a notification system (e.g., the notification system 136) to transmit notifications (e.g., email, SMS messages, etc.) to users of the network system. The notification(s) can include natural language description of the network/system anomaly, including indications of network down-time or an amount of time to resolve the network/system anomaly.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), light transport simulation (e.g., ray-tracing, path tracing, etc.), collaborative content creation for three-dimensional (3D) assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), systems for performing light transport simulation, systems for performing collaborative content creation for 3D assets, systems implemented at least partially using cloud computing resources, and/or other types of systems.

### Example Large Language Models

Large language models (LLMs) are a type of generative artificial intelligence (AI) that can understand, summarize, translate, or otherwise generate human-like text based on the context provided in input prompts or queries. These language models are often considered “large” based on their training on massive datasets and having architectures with large number of learnable network parameters (weights and biases), with popular LLMs having millions or billions of parameters. LLMs have become proficient in summarizing textual data, analyzing and extracting insights from data, and generating new text in user-specified styles, tones, or formats. Some LLMs like the early versions of chatbots (e.g., ChatGPT) focus exclusively on text processing, whereas some multimodal LLMs can accept, understand, and/or generate text along with other types of content like images, audio, and/or video. For example, visual language models (VLMs) are a type of LLM that can accept visual and textual input and/or generate visual and textual output.

There are different types of LLM architectures that use different techniques for understanding and generating human-like text. Some early LLM architectures used recurrent neural networks (RNNs) or long short-term memory networks (LSTMs), whereas many modern LLMs use a transformer architecture that relies on self-attention mechanisms to understand and recognize relationships between words or tokens. An LLM may include encoder and/or decoder block(s). Discriminative or encoder only LLMs like BERT (Bidirectional Encoder Representations from Transformers) are well-suited for tasks that involve language comprehension such as classification, sentiment analysis, question answering, and named entity recognition. Generative or decoder only LLMs like GPT (Generative Pretrained Transformer) are well-suited for tasks that involve language and content generation such as text completion, story generation, and dialogue generation. LLMs that include both encoder and decoder components like T5 (Text-to-Text Transformer) can understand and generate content, making these models well-suited for tasks such as translation and summarization.

LLMs are primarily trained using unsupervised learning, in which an LLM learns patterns from large amounts of unlabeled text data. Due to their extensive training, LLMs often do not require task-specific or domain-specific training. These types of LLMs that have undergone extensive pre-training on vast amounts of unlabeled text data are often referred to as foundation models and are adept at a variety of tasks like question-answering, summarization, filling in missing information, and translation. Some LLMs may be tailored for a specific use case using techniques like prompt tuning, fine-tuning, and/or adding adapters. As described herein, the various LLMs described herein may be adapted to process sequences of tokens representing audio data, video data, text data, and/or combinations thereof.

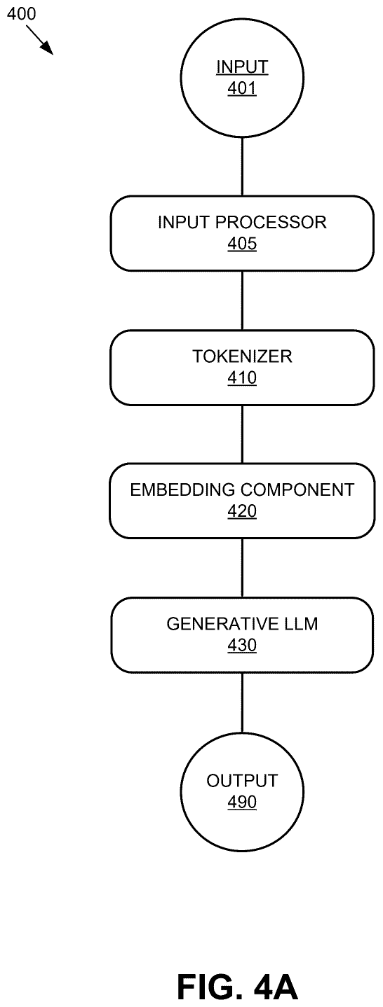

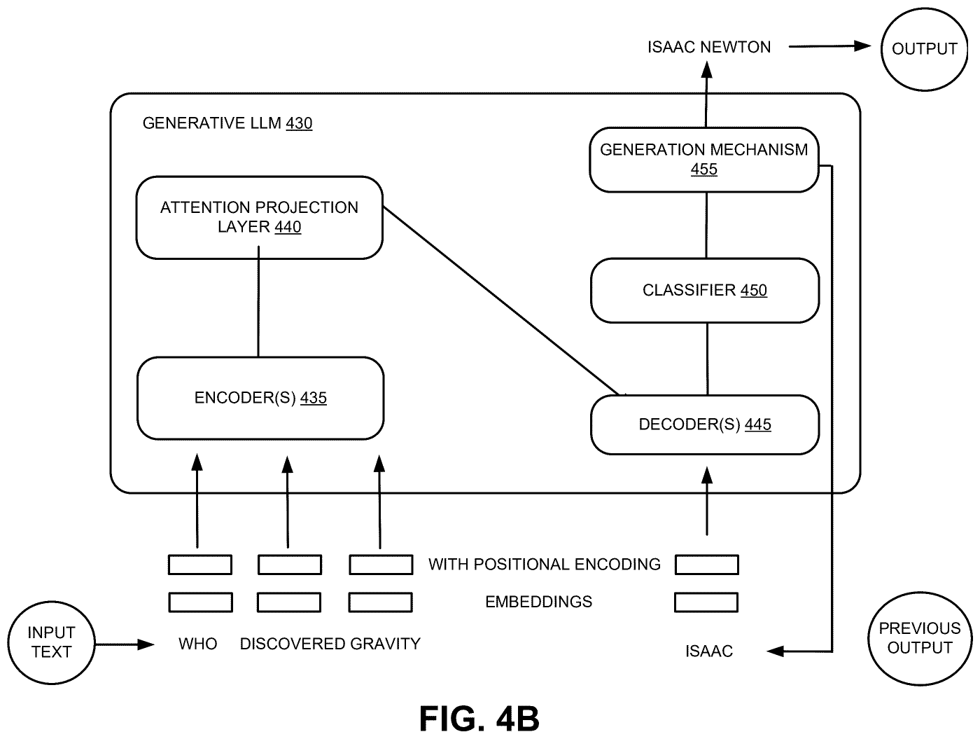

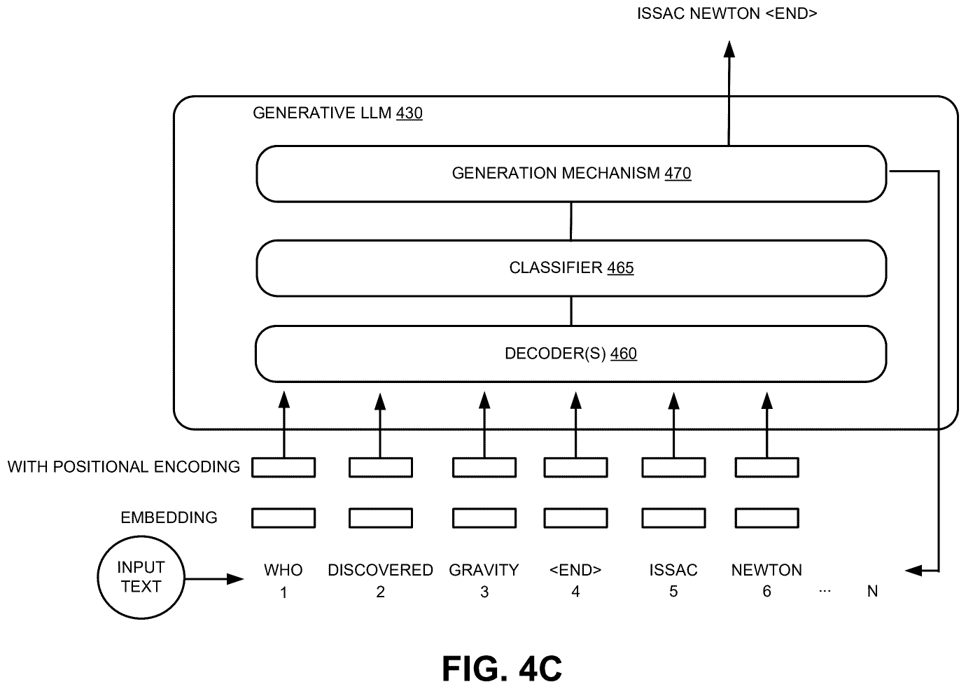

FIG. 4A is a block diagram of an example generative LLM system 400 suitable for use in implementing some embodiments of the present disclosure. In the example illustrated in FIG. 4A, the generative LLM system 400 includes an input processor 405, a tokenizer 410, an embedding component 420, and a generative LLM 430.

At a high level, the input processor 405 may receive an input 401 comprising text and other types of input data, depending on the architecture of the generative LLM 430. Typically, the input 401 includes plain text in the form of one or more sentences, paragraphs, or documents. Additionally, or alternatively, the input 401 may include numerical sequences, precomputed embeddings (e.g., word or sentence embeddings), and/or structured data (e.g., in tabular formats, JSON, or XML). In some implementations in which the generative LLM 430 is capable of processing multimodal inputs, the input 401 may combine text with other types of media data such as audio data, video data, image data, combinations thereof, and/or other types of input data. Taking raw input text as an example, the input processor 405 may prepare raw input text in various ways. For example, the input processor 405 may perform various types of text cleaning to remove noise (e.g., special characters, punctuation, HTML tags, stopwords) from relevant textual content. In an example involving stopwords (common words that tend to carry little semantic meaning), the input processor 405 may remove stopwords to reduce noise and focus the generative LLM 430 on more meaningful content. The input processor 405 may apply text normalization, for example, by converting all characters to lowercase, removing accents, and/or or handling special cases like contractions or abbreviations to ensure consistency. These are just a few examples, and other types of input processing may be applied.

The tokenizer 410 may segment the (e.g., processed) text into smaller units (tokens) for subsequent analysis and processing. The tokens may represent individual words, subwords, or characters, depending on the implementation. Word-based tokenization divides the text into individual words, treating each word as a separate token. Subword tokenization breaks down words into smaller meaningful units (e.g., prefixes, suffixes, stems), enabling the generative LLM 430 to understand morphological variations and handle out-of-vocabulary words more effectively. Character-based tokenization represents each character as a separate token, enabling the generative LLM 430 to process text at a fine-grained level. The choice of tokenization strategy may depend on factors such as the language being processed, the task at hand, and/or characteristics of the training dataset. As such, the tokenizer 410 may convert the (e.g., processed) text into a structured format.

The embedding component 420 may use any known embedding technique to transform discrete tokens into (e.g., dense, continuous vector) representations of semantic meaning. For example, the embedding component 420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data, the input processor 401 may resize the image data to a standard size compatible with format of a corresponding input channel and/or may normalize pixel values to a common range (e.g., 0 to 1) to ensure a consistent representation, and the embedding component 420 may encode the image data using any known technique (e.g., using one or more convolutional neural networks (CNNs) to extract visual features). In some implementations in which the input 401 includes audio data, the input processor 401 may resample an audio file to a consistent sampling rate for uniform processing, and the embedding component 420 may use any known technique to extract and encode audio features. In some implementations in which the input 401 includes video data, the input processor 401 may extract frames or apply resizing to extracted frames, and the embedding component 420 may extract features such as optical flow embeddings or video embeddings and/or may encode temporal information or sequences of frames. In some implementations in which the input 401 includes multimodal data, the embedding component 420 may fuse representations of the different types of data (e.g., text, image, audio) using techniques like early fusion (concatenation), late fusion (sequential processing), attention-based fusion, etc.

The generative LLM 430 and/or other components of the generative LLM system 400 may use different types of neural network architectures depending on the implementation. Transformer-based architectures such as those used in models like GPT typically include self-attention mechanisms that weigh the importance of different words or tokens in the input sequence and feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 may apply an encoded representation of the input 401 to the generative LLM 430, and the generative LLM 430 may process the encoded representation of the input 401 to generate an output 490, which may include responsive text and/or other types of data.

FIG. 4B is a block diagram of an example implementation in which the generative LLM 430 includes a transformer encoder-decoder. For example, assume input text such as “Who discovered gravity” is tokenized (e.g., by the tokenizer 410 of FIG. 4A) into tokens such as words, and each token is encoded (e.g., by the embedding component 420 of FIG. 94A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 435 of the generative LLM 430.

In an example implementation, the encoder(s) 435 form an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 440 may convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 may generate a first token, and the generation mechanism 455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 may output some decoded (e.g., vector) representation of the input being applied during a particular pass. The classifier 450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 may select or sample a word or token based on a corresponding predicted probability (e.g., select the word with the highest predicted probability) and append it to the output from a previous pass, generating each word or token sequentially. The generation mechanism 455 may repeat the process, triggering successive decoder inputs and corresponding predictions until selecting or sampling a symbol or token that represents the end of the response, at which point, the generation mechanism 455 may output the generated response.

FIG. 4C is a block diagram of an example implementation in which the generative LLM 430 includes a decoder-only transformer architecture. For example, the decoder(s) 460 of FIG. 4C may operate similarly as the decoder(s) 445 of FIG. 4B except each of the decoder(s) 460 of FIG. 4C omits the encoder-decoder self-attention layer (since there is no encoder in this implementation). As such, the decoder(s) 460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 460. As with the decoder(s) 445 of FIG. 4B, each token (e.g., word) may flow through a separate path in the decoder(s) 460, and the decoder(s) 460, a classifier 465, and a generation mechanism 470 may use auto-regression to sequentially generate one token at a time until predicting a symbol or token that represents the end of the response. The classifier 465 and the generation mechanism 470 may operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

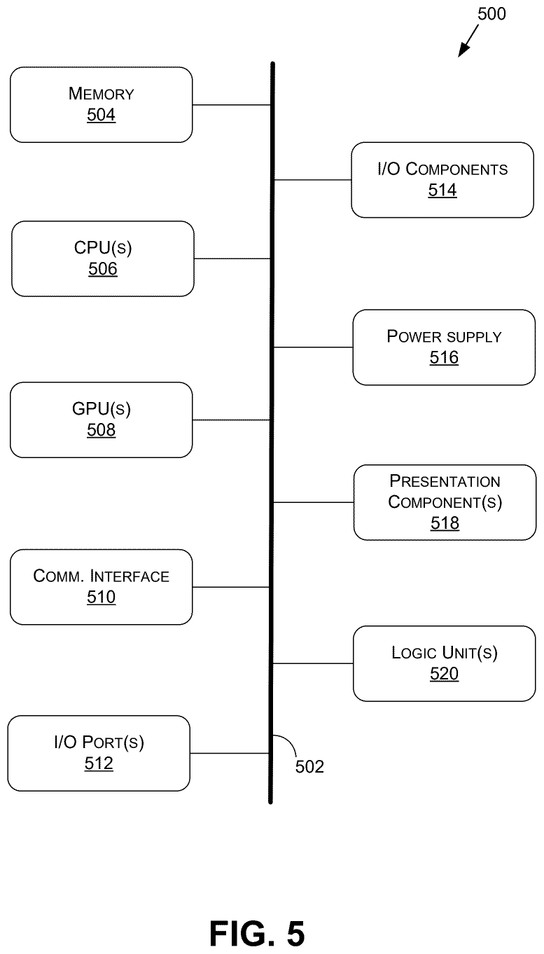

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

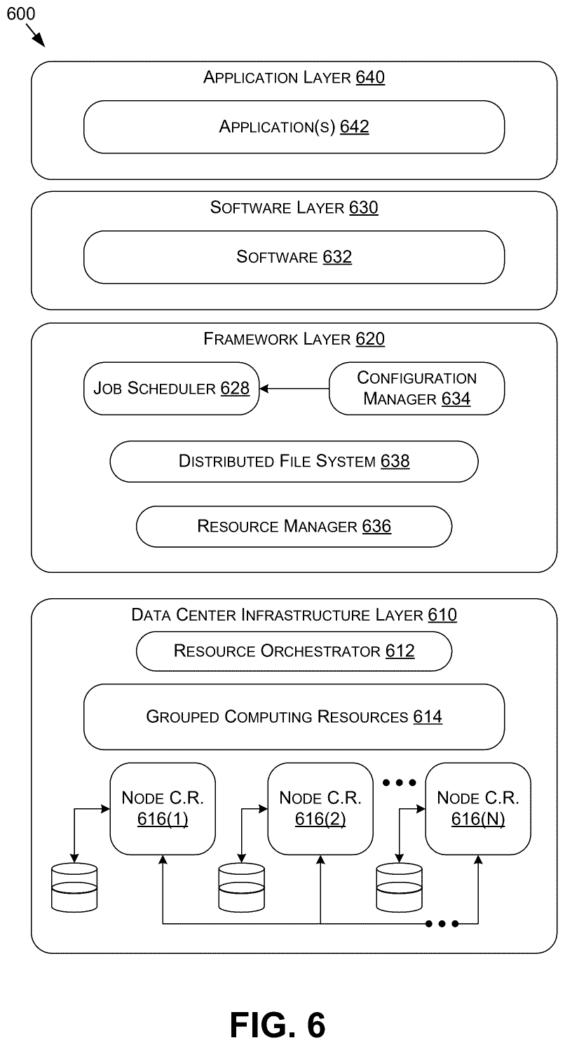

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may use distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
classify at least one log of a set of logs produced by a network system as corresponding to a network anomaly;
upon classifying the at least one log as corresponding to the network anomaly, generate, using a machine-learning model and the at least one log, a command to produce a message comprising natural language output identifying the network anomaly; and
cause performance of one or more maintenance actions on the network system based on the message to address the network anomaly.

2. The one or more processors of claim 1, wherein the machine-learning model comprises a large language model.

3. The one or more processors of claim 1, wherein the natural language output further identifies a potential solution for the network anomaly, and wherein the one or more circuits are to:
generate, based at least on the command, a service ticket identifying the network anomaly and the potential solution for the network anomaly.

4. The one or more processors of claim 1, wherein the one or more circuits are to transmit the command to at least one external system associated with the network system.

5. The one or more processors of claim 1, wherein the one or more circuits are to:
receive, from a computing device, a natural language query corresponding to the network system; and
generate, using the machine-learning model and the natural language query, a second natural language output corresponding to the natural language query.

6. The one or more processors of claim 5, wherein the one or more circuits are to:
retrieve a dataset corresponding to the natural language query from a data source; and
generate the second natural language output using the natural language query and the dataset.

7. The one or more processors of claim 1, wherein the one or more circuits are to:
generate, using the machine-learning model and the at least one log, a second command to restart at least one node of the network system.

8. The one or more processors of claim 1, wherein the one or more circuits are to:
identify a subset of the set of logs corresponding to operation of the network system during a predetermined time period; and
generate, using the machine-learning model and the subset, a summary of the operation of the network system during the predetermined time period.

9. The one or more processors of claim 1, wherein the one or more circuits are to:
update the machine-learning model based at least on a historical service ticket and a corresponding solution identified in a data source corresponding to the network system.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for performing generative AI operations using a vision language model (VLM);
a system for generating synthetic data;
a system incorporating one or more virtual machines (VMs);
a system implemented at least partially in a data center; or
a system implemented at least partially using cloud computing resources.

11. A system comprising:
one or more processors to:
identify a plurality of network logs corresponding to at least one historical service ticket of a network system;
generate a training dataset using at least one of the plurality of network logs or the at least one historical service ticket, at least one training example of the training dataset indicating log data indicative of a network anomaly of the network system and a natural language response indicating a resolution to the network anomaly;
update, using the training dataset, a language model to generate natural language output corresponding to input network logs; and
cause control of at least one network node of the network system to address a network anomaly indicated in an input network log of the input network logs.

12. The system of claim 11, wherein the one or more processors are to:
update, using the training dataset, the language model to generate the natural language output corresponding to the input network logs in response to natural language queries.

13. The system of claim 11, wherein the one or more processors are to:
update, using the training dataset, the language model to generate commands for at least one external system based at least on the input network logs.

14. The system of claim 11, wherein the one or more processors are to:
generate the training dataset to include a training example comprising at least a portion of a dataset corresponding to the log data; and
update the language model using the training example to generate the resolution to the network anomaly according to the dataset.

15. The system of claim 11, wherein the plurality of network logs further comprises at least one annotation relating to the at least one network anomaly, and wherein the training dataset is generated further based at least on the at least one annotation.

16. The system of claim 11, wherein the one or more processors are to:
update the language model to generate instructions to control the at least one network node of the network system.

17. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for performing generative AI operations using a vision language model (VLM);
a system for generating synthetic data;
a system incorporating one or more virtual machines (VMs);
a system implemented at least partially in a data center; or a system implemented at least partially using cloud computing resources.

18. A method, comprising:
classifying, using one or more processors, at least one log of a set of logs produced by a network system as corresponding to a network anomaly;
upon classifying the at least one log as corresponding to the network anomaly, generating, using the one or more processors and a machine-learning model and the at least one log, a command to produce a message comprising natural language output identifying the network anomaly; and
causing, using the one or more processors, performance of one or more maintenance actions on the network system based on the message to address the network anomaly.

19. The method of claim 18, wherein the natural language output further identifies a potential solution for the network anomaly, and wherein the method further comprises:
generating, using the one or more processors, based at least on the command, a service ticket identifying the network anomaly and the potential solution for the network anomaly.

20. The method of claim 18, further comprising:
transmitting, using the one or more processors, the command to at least one external system associated with the network system.
